(19) United States
(12) Patent Application Publication
(10) Pub. No.: US 2025/0202371 A1
(43) Pub. Date: Jun. 19, 2025

(54) CONTROLLER FOR ELECTRIC VEHICLE

(71) Applicant: TOYOTA JIDOSHA KABUSHIKI KAISHA, Toyota-shi Aichi-ken (JP)

(72) Inventor: Takashi NOZAWA, Nagoya-shi Aichi-ken (JP)

(73) Assignee: TOYOTA JIDOSHA KABUSHIKI KAISHA, Toyota-shi Aichi-ken (JP)

(21) Appl. No.: 18/958,731

(22) Filed: Nov. 25, 2024

(30) Foreign Application Priority Data
Dec. 13, 2023 (JP) 2023-210242

(51) Int. Cl. H02M 3/335; H02M 3/00

(52) U.S. Cl. CPC H02M 3/33573; H02M 3/003; H02M 3/33571; H02M 3/33584

(57) ABSTRACT

A semiconductor module includes: an external connection terminal; a wiring; and a full bridge circuit. Further, the external connection terminal includes first to fourth connection terminal pairs, the wire includes first to fifth wirings, and the full bridge circuit includes first and second vertical arms, a first vertical arm connects between a first wiring a second wiring, a second vertical arm connects between the third wiring and the second wiring, the fourth wiring connects between a connecting point between upper and lower arm of the first vertical arm and the fifth terminal, and the fifth wiring connects between a connecting point between upper and lower arm of the second vertical arm and the sixth terminal.

CROSS-REFERENCE TO RELATED APPLICATION(S)

The present application claims priority to and incorporates by reference the entire contents of Japanese Patent Application No. 2023-210242 filed in Japan on Dec. 13, 2023.

### BACKGROUND

The present disclosure relates to a semiconductor module.

Japanese Laid-open Patent Publication No. 2020-150574 discloses an isolated DCDC converter in which the first converter and the second converter are coupled via a transformer.

### SUMMARY

There is a need for providing a semiconductor module that can function as a variety of power converters in a simple configuration.

According to an embodiment, a semiconductor module includes: an external connection terminal; a wiring connected to the external connection terminal; and a full bridge circuit including a plurality of switching elements. Further, the external connection terminal includes a first connection terminal pair including a first terminal and a second terminal, a second connection terminal pair including a third terminal and a fourth terminal, a third connection terminal pair including a fifth terminal and a sixth terminal, and a fourth connection terminal pair including a seventh terminal and an eighth terminal, the wiring includes a first wiring connecting the first terminal and the third terminal, a second wiring for connecting the second terminal and the eighth terminal, a third wiring for connecting the fourth terminal and the seventh terminal, a fourth wiring connected to the fifth terminal, and a fifth wiring connected to the sixth terminal, the full bridge circuit includes a first vertical arm for connecting between the first wiring and the second wiring, and a second vertical arm connecting between the third wiring and the second wiring, the fourth wiring connects between a connecting point between an upper arm and a lower arm of the first vertical arm and the fifth terminal, and the fifth wiring connects between a connecting point between an upper arm and a lower arm of the second vertical arm and the sixth terminal.

According to an embodiment, a semiconductor module includes: an external connection terminal; a wiring connected to the external connection terminal; and a half bridge circuit including a plurality of switching elements. Further, the external connection terminal includes a first connection terminal pair including a first terminal and a second terminal, a second connection terminal pair including a third terminal and a fourth terminal, a third connection terminal pair including a fifth terminal and a sixth terminal, and a fourth connection terminal pair including a seventh terminal and an eighth terminal, the wiring includes a first wiring connecting the first terminal and the third terminal, a second wiring for connecting the second terminal and the eighth terminal, a third wiring for connecting the fourth terminal and the seventh terminal, a fourth wiring connected to the fifth terminal, a fifth wiring connected to the sixth terminal, and a sixth wiring connecting between the second wiring and the third wiring, the half bridge circuit includes a vertical arm for connecting between the first wiring and the second wiring, and the fourth wiring connects between a connecting point between an upper arm and a lower arm of the vertical arm and the fifth terminal, and the fifth wiring connects between the sixth wiring and the sixth terminal.

### BRIEF DESCRIPTION OF THE DRAWINGS

FIG. 1 is a schematic diagram illustrating a semiconductor module according to an embodiment;

FIG. 2 is a schematic diagram illustrating a semiconductor module of a first modification;

FIG. 3 is a diagram for explaining a case where the semiconductor module of the first modification is driven as a DCDC converter;

FIG. 4 is a diagram for explaining the semiconductor module according to a first modification is driven as a ACDC converter;

FIG. 5 is a schematic diagram illustrating a semiconductor module according to a second modification; and

FIG. 6 is a schematic diagram illustrating a semiconductor module according to a third modification.

### DETAILED DESCRIPTION

In the configuration described in Japanese Laid-open Patent Publication No. 2020-150574, since in the first converter and the second converter, both the transformer-side interface is an input and output unit of the AC power, it is difficult for the first converter and the second converter to function as a DCDC converter.

Hereinafter, a semiconductor module in the embodiment of the present disclosure will be specifically described. Note that the present disclosure is not limited to the embodiments described below.

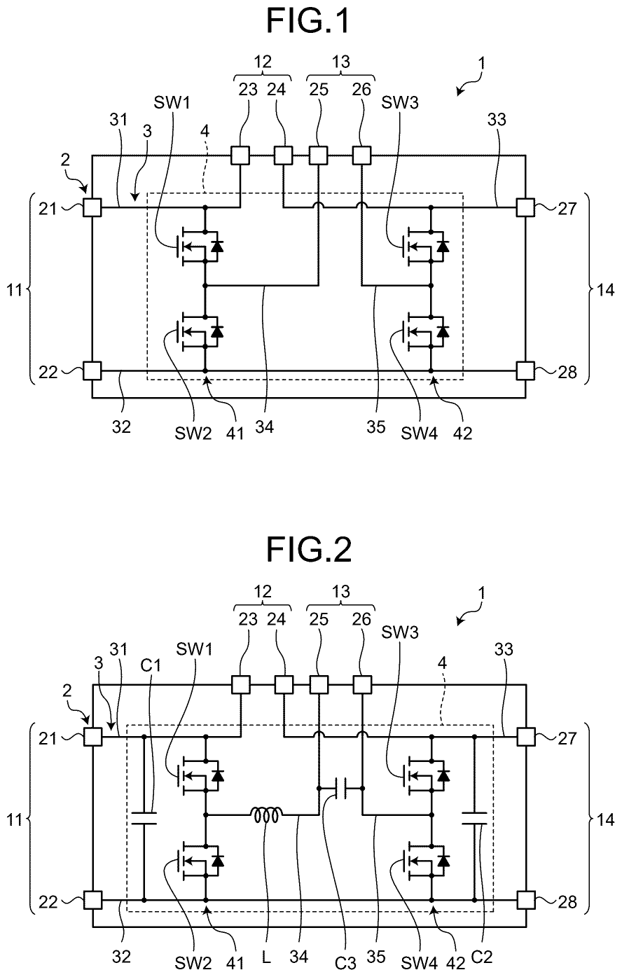

FIG. 1 is a schematic diagram illustrating a semiconductor module in the embodiment. The semiconductor module 1 is a module capable of configuring a variety of power converters by switching the connection. The semiconductor module 1 includes an external connection terminal 2, a wiring 3, and a bridge circuit 4.

The external connection terminal 2 is a terminal for connecting to an external circuit. The external connection terminal 2 includes a first connection terminal pair 11, a second connection terminal pair 12, a third connection terminal pair 13, and a fourth connection terminal pair 14. The first connection terminal pair 11 includes a first terminal 21, and a second terminal 22. The second connection terminal pair 12 includes a third terminal 23, and a fourth terminal 24. The third connection terminal pair 13 includes a fifth terminal 25, and a sixth terminal 26. The fourth connection terminal pair 14 includes a seventh terminal 27, and an eighth terminal 28.

The wiring 3 is a wiring connected to the external connection terminal 2. The wiring 3 includes a first wiring 31 connected to the first terminal 21, a second wiring 32 connected to the second terminal 22, a third wiring 33 connected to the fourth terminal 24, the fourth wiring 34 connected to the fifth terminal 25, and a fifth wiring 35 connected to the sixth terminal 26. The first wiring 31 connects the first terminal 21 and the third terminal 23. The second wiring 32 connects the second terminal 22 and the eighth terminal 28. The third wiring 33 connects the fourth terminal 24 and the seventh terminal 27. The fourth wiring 34 has one end connected to the fifth terminal 25, the other end connected to the bridge circuit 4. The fifth wiring 35 has one end connected to the sixth terminal 26, the other end connected to the bridge circuit 4.

The bridge circuit 4 is a full bridge circuit having a plurality of switching elements. The bridging circuit 4 is constituted by four switching device SW1 to SW4 constituting the two vertical arms 41 and 42. The vertical arms 41 and 42 are each provided with two switching elements. Each switching element diodes are connected in anti-parallel to each other. Every switching device is constituted by an IGBT. Each switching element performs a switching operation in response to a control signal from the control device.

The first vertical arm 41 is a vertical arm in which the first switching element SW1 and the second switching element SW2 are connected in series. In the first vertical arm 41, the first switching element SW1 is an upper arm, the second switching element SW2 is a lower arm. The first vertical arm 41 connects between the first wiring 31 and the second wiring 32.

The second vertical arm 42 is a vertical arm in which the third switching element SW3 and the fourth switching element SW4 are connected in series. In the second vertical arm 42, the third switching element 43 is an upper arm, the fourth switching element SW4 is a lower arm. The second vertical arm 42 connects between the third wiring 33 and the second wiring 32.

In the bridge circuit 4, the wiring 3 is connected to each of the connection points of the switching elements to each other as a pair. The connecting point between the first switching element SW1 and the second switching element SW2 of the first vertical arm 41 is connected to the fourth wire 34. The connecting point between the third switching element SW3 and the fourth switching element SW4 of the second vertical arm 42 is connected to the fifth wire 35. The fourth wiring 34 connects between the connecting point and the fifth terminal 25 of the upper arm and the lower arm of the first vertical arm 41. The fifth wiring 35 connects between the connection point and the sixth terminal 26 of the upper arm and the lower arm of the second vertical arm 42.

In the relationship between the external connection terminal 2 and the bridge circuit 4, the first connection terminal pair 11 is connected to one side of the bridge. Second connection terminal pair 12 is connected to the positive side of the bridge. The third connection terminal pair 13 is connected to the midpoint of the bridge. The fourth connection terminal pair 14 is connected to the other side of the bridge. The midpoint of the bridge is the connection point between the upper arm and the lower arm.

The semiconductor module 1 can be served as a variety of power converters by switching the connection. An external circuit and the output side of the external circuit of the input side is connected to the external connection terminal 2. By appropriately switching the connection on the external circuit side and performing appropriate switching control, it is possible to function the semiconductor module 1 as a variety of power converters.

The external connection terminal 2, the external circuit of the input side to any one of the four connection terminal pairs are connected, and the output side to one of the remaining three connection terminal pairs external circuit is connected. In addition, one of the remaining two contact terminal pairs is electrically opened, and the other is short-circuited. The connection terminal pair is electrically opened means that the connection terminal pair is a state in which the external device (external circuit or component) is not connected anything to the connection terminal pair, the connection terminal pair is electrically opened the connection terminal pair on the external device side of what the external device is connected to. The connection terminal pair is short-circuited means that the connection terminal pair is short-circuited by the external device in a state in which the external device is connected to the connection terminal pair. In this connected state, by the first to fourth switching element SW1˜SW4 included in the bridge circuit 4 performs a switching operation, the semiconductor module 1 converts the input power from the external circuit of the input side to the desired power output to the external circuit. For example, the semiconductor-module can function as a two-way buck-boost converter or a ACDC converter or the like.

Specifically, the semiconductor module 1 may be driven by any one of DCDC mode, ACDC mode, DCAC mode, and Power Factor Correction (PFC) mode. The DCDC mode is a driving state that converts the input DC power into a predetermined voltage and outputs. The ACDC mode is a driving state in which the inputted AC power is converted into DC power and outputted. The DCAC is driven by converting the input DC power into AC power. The PFC mode is a mode for driving as a power factor correction circuit, a driving state for improving the power factor by reducing the phase difference between the voltage and the current.

As a first mode, when the semiconductor module 1 is driven in DCDC mode, the first connection terminal pair 11 becomes an input-output terminal, the fourth connection terminal pair 14 is an input-output terminal. The DCDC mode includes two connection patters, which are a first pattern, in which the first connection terminal pair 11 serves as an input terminal and the fourth connection terminal pair 14 servs as an output terminal, and a second pattern, in which the fourth connection terminal pair 14 serves as an input terminal and the first connection terminal pair 11 serves as an input terminal.

In the DCDC mode of the first pattern, the external DC circuit of the input side is connected to the first connection terminal pair 11, the external DC circuit of the output side is connected to the fourth connection terminal pair 14, the second connection terminal pair 12 is electrically open, and the third connection terminal pair 13 is short-circuited. In this state, the semiconductor module 1 is output from the fourth connection terminal pair 14 converts the DC power input from the first connection terminal pair 11 to a predetermined voltage. In this case, the semiconductor module 1 functions as a buck-boost converter. When functioning as a step-up converter, the semiconductor module 1 outputs to the fourth connection terminal pair 14 by boosting the DC voltage applied to the first connection terminal pair 11. When functioning as a step-down converter, the semiconductor module 1 outputs to the fourth connection terminal pair 14 by stepping down the DC voltage applied to the first connection terminal pair 11.

In the DCDC mode of the second pattern, the external DC circuit of the input side is connected to the fourth connection terminal pair 14, the external DC circuit of the output side is connected to the first connection terminal pair 11, the second connection terminal pair 12 is electrically open, the third connection terminal pair 13 is short-circuited. In this state, the semiconductor module 1 is output from the first connection terminal pair 11 converts the DC power input from the fourth connection terminal pair 14 to a predetermined voltage. In this case, the semiconductor module 1 functions as a buck-boost converter. When functioning as a step-up converter, the semiconductor module 1 outputs to the first connection terminal pair 11 by boosting the DC voltage applied to the fourth connection terminal pair 14. When functioning as a step-down converter, the semiconductor module 1 outputs to the first connection terminal pair 11 by stepping down the DC voltage applied to the fourth connection terminal pair 14.

As the second mode, when the semiconductor module 1 is driven in the ACDC mode, the third connection terminal pair 13 serves as an input terminal, the first connection terminal pair 11 or the fourth connection terminal pair 14 serves as an output terminal. The ACDC mode includes a two connection patterns; which are a first pattern in which the first connection terminal pair 11 serves as an output terminal, and a second pattern, in which the fourth connection terminal pair 14 serves as an output terminal.

In the ACDC mode of the first pattern, the external AC circuit of the input side is connected to the third connection terminal pair 13, the external DC circuit of the output side is connected to the first connection terminal pair 11, the second connection terminal pair 12 is short-circuited, the fourth connection terminal pair 14 is electrically opened. In this state, the semiconductor module 1 converts the AC power input from the third connection terminal pair 13 into DC power and outputs from the first connection terminal pair 11.

In the ACDC mode of the second pattern, the external AC circuit of the input side is connected to the third connection terminal pair 13, the external DC circuit of the output side is connected to the fourth connection terminal pair 14, the second connection terminal pair 12 is short-circuited, the first connection terminal pair 11 is electrically opened. In this state, the semiconductor module 1 converts the AC power input from the third connection terminal pair 13 into DC power and outputs from the fourth connection terminal pair 14.

As the third mode, when the semiconductor module 1 is driven in the DCAC mode, the first connection terminal pair 11 or the fourth connection terminal pair 14 serves as an input terminal, the third connection terminal pair 13 serves as an output terminal. The DCAC mode incudes two connection methods, which are the first pattern, in which the first connection terminal pair 11 serves as an input terminal and a second pattern, in which the fourth connection terminal pair 14 serves as an input terminal.

In the DCAC mode of the first pattern, the external DC circuit of the input side is connected to the first connection terminal pair 11, the external AC circuit of the output side is connected to the third connection terminal pair 13, the second connection terminal pair 12 is short-circuited, the fourth connection terminal pair 14 is electrically opened. In this state, the semiconductor module 1 converts the DC power input from the first connection terminal pair 11 into AC power and outputs from the third connection terminal pair 13.

In the DCAC mode of the second pattern, the external DC circuit of the input side is connected to the fourth connection terminal pair 14, the external AC circuit of the output side is connected to the third connection terminal pair 13, the second connection terminal pair 12 is short-circuited, the first connection terminal pair 11 is electrically opened. In this state, the semiconductor module 1 converts the DC power input from the fourth connection terminal pair 14 into AC power and outputs from the third connection terminal pair 13.

As the fourth mode, when the semiconductor module 1 is driven in the PFC mode, the third connection terminal pair 13 serves as an input terminal, the first connection terminal pair 11 or the fourth connection terminal pair 14 serves as an output terminal. The PFC mode includes two connection methods, which are a first pattern, in which the first connection terminal pair 11 serves as an output terminal, and a second pattern, in which the fourth connection terminal pair 14 serves as an output terminal.

In the PFC mode of the first pattern, the external AC circuit of the input side is connected to the third connection terminal pair 13, the external DC circuit of the output side is connected to the first connection terminal pair 11, the second connection terminal pair 12 is short-circuited, the fourth connection terminal pair 14 is electrically opened. In this state, the semiconductor module 1 converts the AC power input from the third connection terminal pair 13 into DC power and outputs from the first connection terminal pair 11.

In the PFC mode of the second pattern, the external AC circuit of the input side is connected to the third connection terminal pair 13, the external DC circuit of the output side is connected to the fourth connection terminal pair 14, the second connection terminal pair 12 is short-circuited, the first connection terminal pair 11 is electrically opened. In this state, the semiconductor module 1 converts the AC power input from the third connection terminal pair 13 into DC power and outputs from the fourth connection terminal pair 14.

Thus, in the semiconductor module 1, either two of the first connection terminal pair 11 and the third connection terminal pair 13 and the fourth connection terminal pair 14, different connection destinations are connected. In this connection state, the semiconductor module 1 outputs to the other connection destination converts the power input from one connection destination to the desired power.

As described above, according to the embodiment, by appropriately switching the connection on the external circuit side and by performing appropriate switching control, it is possible to apply the semiconductor module 1 to a variety of power converters. Further, the cost reduction can be expected by the mass-production effect.

The semiconductor module 1 is not limited to the configuration illustrated in FIG. 1, it may be built-in control circuit and sensors. For example, the semiconductor module 1 may include a driving circuit of a switching element, a control circuit for determining ON and OFF of the driving circuit, or may include a power supply for driving the driving circuit. The semiconductor module 1 may include a function of communicating with the abnormal stop or an external circuit. The semiconductor module 1 may include a communication circuit with an external circuit. The semiconductor module 1 may include a sensor such as a voltage sensor, a current sensor or a thermistor.

Further, the semiconductor module 1 may incorporate a passive component and a sub-circuit. For example the semiconductor module 1 may be configured to include a reactor and a capacitor. A reactor or capacitor may be mounted on the semiconductor module 1, or may be mounted to an external connection destination.

FIG. 2 is a schematic diagram illustrating a semiconductor module according to a first modification. The semiconductor module in the first modification includes a first capacitor C1, a second capacitor C2, a third capacitor C3, and a reactor L.

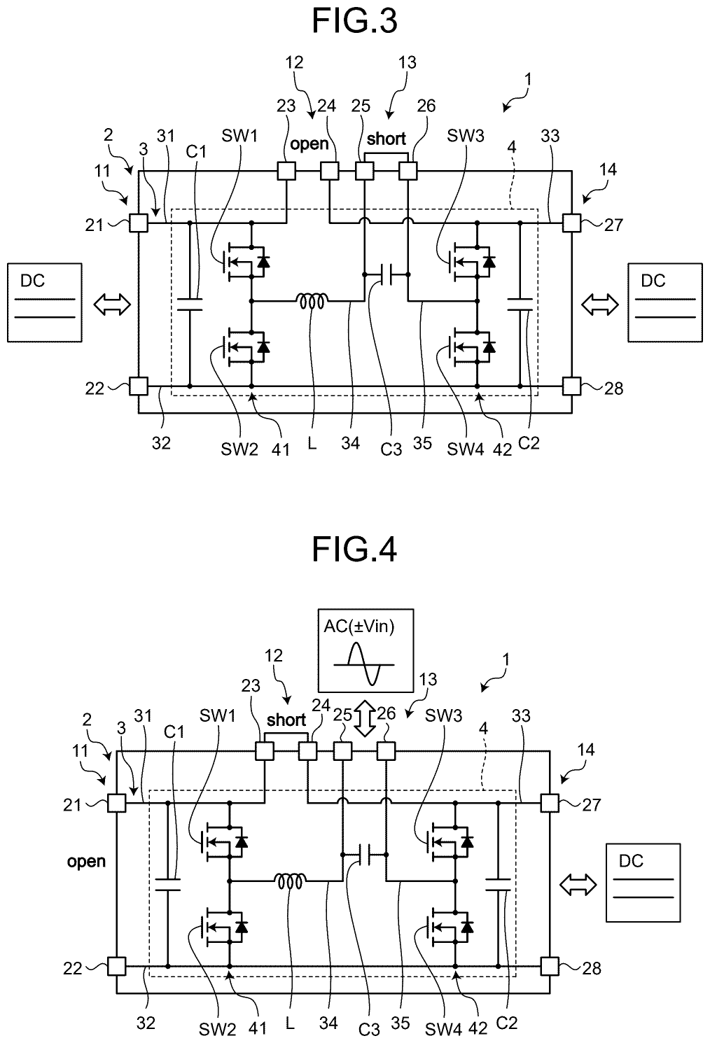

As illustrated in FIG. 2, the first capacitor C1 connects between the first wiring 31 and the second wiring 32. The first capacitor C1 is connected in parallel with the first vertical arms 41, and is connected between the first terminal 21 and the second terminal 22 of the first connecting terminal pair 11. As illustrated in FIG. 3, in the driving state in which the first connection terminal pair 11 serves as an input-output terminal of the DC power, the first capacitor C1 functions as a smoothing capacitor for smoothing the voltage of the DC power input and output to the first connection terminal pair 11.

The second capacitor C2 connects between the third wiring 33 and the second wiring 32. The second capacitor C2 is connected in parallel with the second vertical arm 42, and is connected between the seventh terminal 27 and the eighth terminal 28 of the fourth connecting terminal pair 14. As illustrated in FIGS. 2 and 3, in the driving state in which the fourth connection terminal pair 14 serves as an input-output terminal of the DC power, the second capacitor C2 functions as a smoothing capacitor for smoothing the voltage of the DC power input and output to the fourth connection terminal pair 14.

The third capacitor C3 connects between the fourth wiring 34 and the fifth wiring 35. The reactor L is provided on the fourth wiring 34. The third capacitor C3 and the reactor L constitute a LC filters connected between the fifth terminal 25 of the third connecting terminal pair 13 and the sixth terminal 26. As illustrated in FIG. 4, in the driving state in which the third connecting terminal pair 13 serves as an input-output terminal of the AC power, the reactor L and the third capacitor C3 functions as LC filters.

The semiconductor module 1 of the first modification is not limited to the configuration illustrated in FIGS. 1 and 2. For example, the first connecting terminal pair 11 may be connected coils and LC filters are not limited to the first capacitor C1. The fourth connecting terminal pair 14 may be connected coils and LC filters are not limited to the second capacitor C2. The third connecting terminal pair 13 may be connected to only an LC filters but may be connected to a capacitor or coil.

Further, as illustrated in FIG. 4, when driving the semiconductor module 1 of the first modification in the ACDC mode or the DCAC mode or the PFC mode, the first capacitor C1 may not be provided. In other words, it is sufficient that the capacitor is provided only on the connection terminal opposite side which is connected to a circuit external to the DC side. In the embodiment illustrated in FIG. 4, it is sufficient that the second capacitor C2 is provided since the fourth connection terminal pair 14 serves as an input-output terminal, the first capacitor C1 of the first connection terminal pair 11 side which is electrically open may not be provided. On the contrary, when the first connection terminal pair 11 and the input-output terminal, it is sufficient that the first capacitor C1 is provided, the second capacitor C2 of the fourth connection terminal pair 14 side which is electrically open it may not be provided.

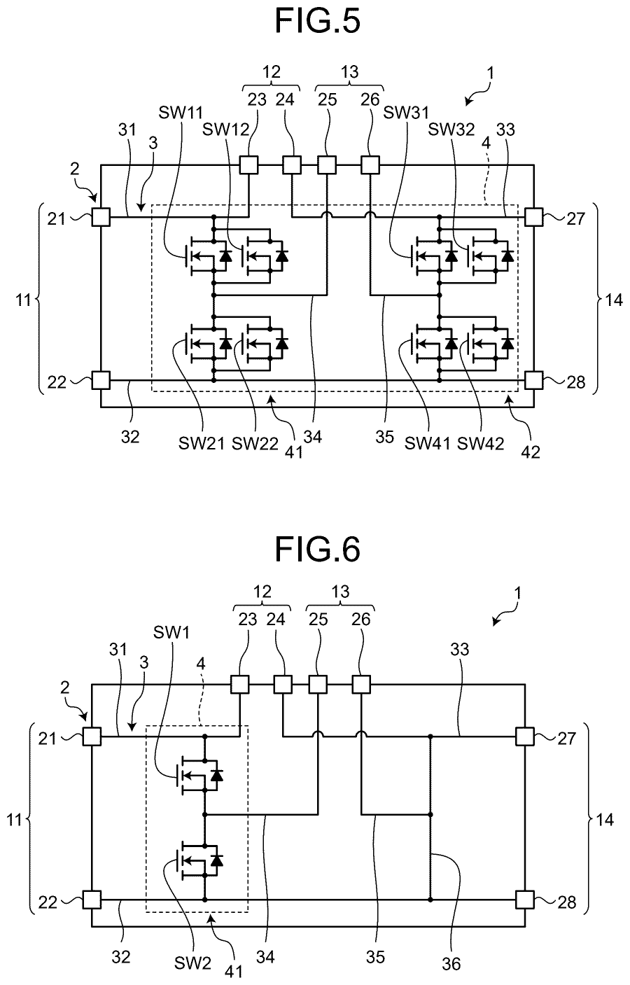

FIG. 5 is a schematic diagram illustrating a semiconductor module of the second modification. The semiconductor module 1 in the second modification includes a bridge circuit 4, in which two switching elements are connected in parallel. The upper arm of the first vertical arm 41 is an element, in which a first switching element SW11 and the switching element SW12 are elements connected in parallel. The lower arm of the first vertical arm 41 is an element, in which the second switching element SW21 and the switching element SW22 are connected in parallel. The upper arm of the second vertical arm 42 is an element, in which a third switching element SW31 and the switching element SW32 are elements connected in parallel. The lower arm of the second vertical arm 42 is an element, in which the fourth switching element SW41 and the switching element SW42 are connected in parallel.

FIG. 6 is a schematic diagram illustrating a semiconductor module according to a third modification. The semiconductor module 1 in the third modification includes a bridge circuit 4 configured in a half-bridge circuit, and a wiring 3 including the sixth wiring 36. The bridge circuit 4 is a half-bridge circuit has a first vertical arm 41. The sixth wiring 36 connects between the third wiring 33 and the second wiring 32. The fifth wiring 35 connects between the sixth terminal 26 and the sixth wiring 36. The semiconductor module 1 can be driven by any one of the DCDC mode, the ACDC mode, the DCAC mode, and the PFC mode.

In the present disclosure, it is possible to function as a variety of power converters in a simple configuration.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A semiconductor module comprising:
an external connection terminal;
a wiring connected to the external connection terminal; and
a full bridge circuit including a plurality of switching elements, wherein
the external connection terminal includes
a first connection terminal pair including a first terminal and a second terminal,
a second connection terminal pair including a third terminal and a fourth terminal,
a third connection terminal pair including a fifth terminal and a sixth terminal, and
a fourth connection terminal pair including a seventh terminal and an eighth terminal,
the wiring includes
a first wiring connecting the first terminal and the third terminal,
a second wiring for connecting the second terminal and the eighth terminal,
a third wiring for connecting the fourth terminal and the seventh terminal,
a fourth wiring connected to the fifth terminal, and
a fifth wiring connected to the sixth terminal, the full bridge circuit includes
a first vertical arm for connecting between the first wiring and the second wiring, and
a second vertical arm connecting between the third wiring and the second wiring,
the fourth wiring connects between a connecting point between an upper arm and a lower arm of the first vertical arm and the fifth terminal, and
the fifth wiring connects between a connecting point between an upper arm and a lower arm of the second vertical arm and the sixth terminal.

2. The semiconductor module according to claim 1, wherein
the semiconductor module is set in a driving state, in which when the second connection terminal pair is short-circuited or electrically open, and any two of the connection terminal pairs selected from among a group consisting of the first connection terminal pair, the third connection terminal pair, and the fourth connection terminal pair are connected to respective connecting destinations, which are different from each other, power input from one of the connecting destinations is output from another of the connecting destinations, and
in the driving state, one of a plurality of modes is operated, and
the plurality of modes includes
a first mode, in which input DC power is converted into and output as a predetermined voltage,
a second mode, in which input DC power is converted into and output as AC power,
a third mode, in which input AC power is converted into and output as DC power, and
a fourth mode, in which serving as a Power Factor Correction (PFC) circuit.

3. The semiconductor module according to claim 2, wherein
in the first mode,
the connection destination of a first AC side is connected to the first connection terminal pair,
the connection destination of a second AC side is connected to the fourth connection terminal pair,
the second connection terminal pair is electrically opened, and
the third connection terminal pair is shorted.

4. The semiconductor module according to claim 2, wherein
in any of the second mode, the third mode, and the second mode,
the connection destination on AC side is connected to the third connection terminal pair,
the connection destination on DC side is connected to one of the first connection terminal pair and
the fourth connection terminal pair, one of the first connection terminal pair and
the fourth connection terminal pair is electrically opened, and
the second connection terminal pair is shortened.

5. A semiconductor module comprising:
an external connection terminal;
a wiring connected to the external connection terminal; and
a half bridge circuit including a plurality of switching elements, wherein
the external connection terminal includes
a first connection terminal pair including a first terminal and a second terminal,
a second connection terminal pair including a third terminal and a fourth terminal,
a third connection terminal pair including a fifth terminal and a sixth terminal, and
a fourth connection terminal pair including a seventh terminal and an eighth terminal,
the wiring includes
a first wiring connecting the first terminal and the third terminal,
a second wiring for connecting the second terminal and the eighth terminal,
a third wiring for connecting the fourth terminal and the seventh terminal,
a fourth wiring connected to the fifth terminal,
a fifth wiring connected to the sixth terminal, and
a sixth wiring connecting between the second wiring and the third wiring,
the half bridge circuit includes a vertical arm for connecting between the first wiring and the second wiring, and
the fourth wiring connects between a connecting point between an upper arm and a lower arm of the vertical arm and the fifth terminal, and
the fifth wiring connects between the sixth wiring and the sixth terminal.
